(19) United States
(12) Patent Application Publication
(10) Pub. No.: US 2025/0109727 A1
(43) Pub. Date: Apr. 3, 2025

(54) VEHICLE

(71) Applicant: KAWASAKI MOTORS, LTD., Akashi-shi (JP)

(72) Inventors: Keigo ASAKURA, Akashi-shi (JP); Yu TSUDOME, Akashi-shi (JP); Kaoru MURAKAMI, Akashi-shi (JP); Wachirakrit INHANGWA, Rayong (TH)

(73) Assignee: KAWASAKI MOTORS, LTD., (omitted)

(21) Appl. No.: 18/897,334

(22) Filed: Sep. 26, 2024

(30) Foreign Application Priority Data
Sep. 29, 2023 (JP) 2023-170580

(51) Int. Cl. F02M 35/024; F02M 35/16

(52) U.S. Cl. CPC F02M 35/024; F02M 35/162

(57) ABSTRACT

There is provided a vehicle including: an internal combustion engine having a combustion chamber; an exhaust path through which exhaust gas from the combustion chamber flows; an air cleaner having a filter that purifies outside air and a clean space into which clean air that passes through the filter flows; and a secondary air flow path that connects the clean space of the air cleaner to the exhaust path. The secondary air flow path includes: a first flow path connected to the clean space of the air cleaner; a second flow path connected to the exhaust path; and an intermediate chamber that has an inflow port connected to the first flow path and an outflow port connected to the second flow path, and that is disposed between the first flow path and the second flow path.

### CROSS-REFERENCE TO RELATED APPLICATIONS

This application is based on and claims priority under 35 USC 119 from Japanese Patent Application No. 2023-170580 filed on Sep. 29, 2023, the contents of which are incorporated herein by reference.

### TECHNICAL FIELD

The present disclosure relates to a vehicle, and more particularly to a vehicle including a secondary air supply structure in which secondary air is supplied from an air cleaner to an exhaust path through which exhaust gas from an internal combustion engine flows.

### BACKGROUND ART

There is known a vehicle including a secondary air supply structure in which secondary air is supplied to an exhaust path through which exhaust gas from an internal combustion engine flows to promote purification of the exhaust gas by burning unburned gas in the exhaust gas. For example, JPH05-321657A describes that in a motorcycle, secondary air is introduced from an air cleaner into an exhaust port of an engine to promote oxidation of unburned gas components in exhaust gas from the engine.

When an internal combustion engine is operating, a pressure of the exhaust path pulsates. Specifically, in the exhaust path of the internal combustion engine, a positive pressure is generated in an exhaust stroke, and a negative pressure is generated at a specific timing between the exhaust stroke and a next exhaust stroke. That is, the negative pressure is intermittently generated in the exhaust path, and a duration of the negative pressure is short. Therefore, when a secondary air flow path for connecting the air cleaner to the exhaust path becomes long, secondary air having a sufficient flow rate cannot be drawn into the exhaust path from the air cleaner due to the negative pressure of the exhaust path.

On the other hand, even if the air cleaner is arranged such that the secondary air flow path is shortened, it is difficult to change a position of the air cleaner due to restriction on an arrangement space. In addition, when an amount of secondary air supplied to the exhaust path is increased by enlarging a diameter of a secondary air introduction hole of the internal combustion engine, a cost increases, and the manufacturing is difficult when the internal combustion engine does not have sufficient structural capacity. In addition, the cost also increases when the purification of the exhaust gas is promoted by increasing an amount of catalyst arranged in the exhaust path.

### SUMMARY OF INVENTION

Therefore, the present disclosure provides a vehicle including: an internal combustion engine having a combustion chamber; an exhaust path through which exhaust gas from the combustion chamber flows; an air cleaner having a filter that purifies outside air and a clean space into which clean air that passes through the filter flows; and a secondary air flow path that connects the clean space of the air cleaner to the exhaust path. The secondary air flow path includes: a first flow path connected to the clean space of the air cleaner; a second flow path connected to the exhaust path; and an intermediate chamber that has an inflow port connected to the first flow path and an outflow port connected to the second flow path, and that is disposed between the first flow path and the second flow path.

According to the above aspect of the present disclosure, the vehicle includes the secondary air supply structure that purifies the exhaust gas by supplying the secondary air from the air cleaner to the exhaust path through which the exhaust gas from the internal combustion engine flows. The present disclosure provides a technique that is possible to favorably purify the exhaust gas by burning the unburned gas in the exhaust gas while preventing an increase in cost even when it is difficult to change the position of the air cleaner due to the restriction on the arrangement space.

### BRIEF DESCRIPTION OF DRAWINGS

FIG. 1 is an external view of a main part of a vehicle according to a first embodiment, as viewed from a right side;

FIG. 2 is a cross-sectional view of an air box in FIG. 1;

FIG. 3 is an external view of the air box in FIG. 1 as viewed from a diagonally forward right direction; and

FIG. 4 is an external view of a main part of a vehicle according to a second embodiment as viewed from a diagonally forward right direction.

### DESCRIPTION OF EMBODIMENTS

Hereinafter, embodiments of the present disclosure will be described with reference to the drawings. Directions to be shown later are based on directions viewed from a rider of a vehicle 1. The terms “upstream” and “downstream” to be shown later are based on a secondary air flow direction of the secondary air flow path 9 from an air cleaner 4 toward an exhaust path 8.

### First Embodiment

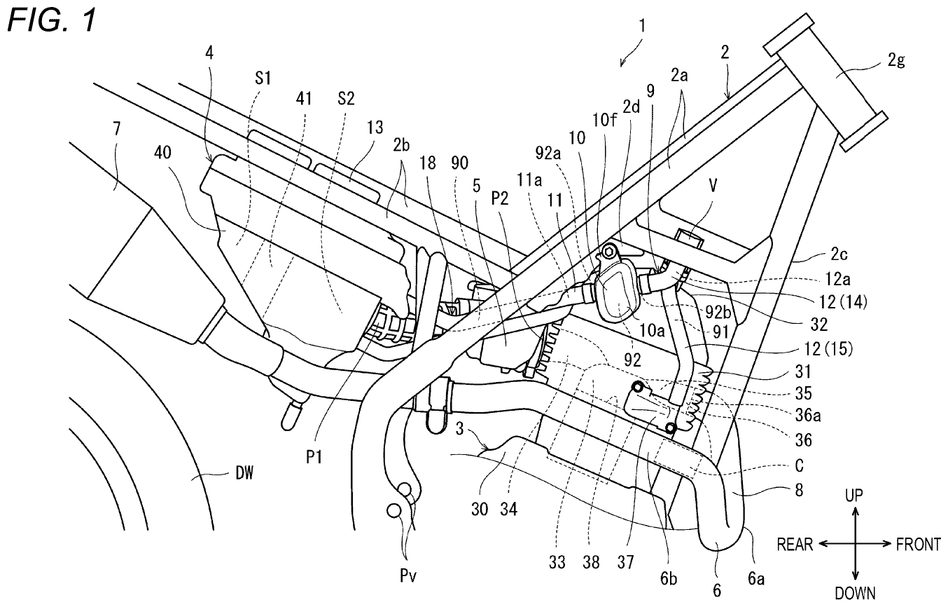

FIG. 1 is an external view of a main part of the vehicle 1 according to a first embodiment, as viewed from a right side. The vehicle 1 is, for example, a wheeled vehicle. The vehicle 1 according to the present embodiment is a straddle-type vehicle on which the rider rides. The straddle-type vehicle is, for example, a motorcycle. As illustrated in FIG. 1, the vehicle 1 includes a vehicle body frame 2, an internal combustion engine 3, a drive wheel DW, an air cleaner 4, a throttle body 5, an exhaust pipe 6, and a muffler 7. As will be described in detail later, the vehicle 1 further includes a secondary air supply structure 18 through which secondary air is supplied from the air cleaner 4 to an exhaust path 8 through which exhaust gas from the internal combustion engine 3 flows. The secondary air supply structure 18 has a secondary air flow path 9. The secondary air supply structure 18 according to the present embodiment is a structure of a suction type in which secondary air is suctioned into the exhaust path 8 from the secondary air flow path 9 by a negative pressure generated in the exhaust path 8 when the internal combustion engine 3 is operating.

The vehicle body frame 2 extends in a front-rear direction of the vehicle 1. The vehicle body frame 2 supports the internal combustion engine 3, the air cleaner 4, and the muffler 7. The vehicle body frame 2 includes a plurality of frame portions. As an example, the vehicle body frame 2 includes a head pipe 2g, a pair of left and right main frame portions 2a extending rearward from the head pipe 2g, seat frame portions 2b each extending rearward from an intermediate portion of each main frame portion 2a, and a lower frame portion 2c including a down region extending downward from the head pipe 2g and a lower region extending rearward from a lower end of the down region and connected to the main frame portions 2a. The vehicle body frame 2 further includes a bracket 2d to which an attachment portion 10f of an air box 10 to be described later is attached. A lower end of the main frame portion 2a has a shaft hole Pv. A pivot shaft that pivotably supports a front end of a swing arm that supports the drive wheel DW is attached to the shaft hole Pv. The bracket 2d extends downward from a lower side surface of the main frame portion 2a.

The internal combustion engine 3 includes a crankcase 30, a cylinder block 31 disposed above the crankcase 30, and a cylinder head cover 32 disposed above the cylinder block 31. The internal combustion engine 3 further includes a combustion chamber 33, a piston 38, an in-engine intake flow path 34 through which intake air supplied from the outside toward the combustion chamber 33 flows, and an in-engine exhaust flow path 35 through which exhaust gas from the combustion chamber 33 flows. The in-engine intake flow path 34 includes an intake port of the internal combustion engine 3. The combustion chamber 33 and the flow paths 34 and 35 are disposed inside the cylinder block 31. In the vehicle 1, the internal combustion engine 3 is a driving source for traveling. As an example, the internal combustion engine 3 is a single-cylinder engine. The internal combustion engine 3 is a four-stroke engine, and may be a two-stroke engine. The drive wheel DW is driven by a rotational driving force of the internal combustion engine 3. In the vehicle 1 which is a motorcycle, the drive wheel DW is a rear wheel.

The air cleaner 4 generates purified air to be supplied to the internal combustion engine 3. The air cleaner 4 includes an air cleaner case 40 and a filter 41 that is housed in the air cleaner case 40 and purifies outside air supplied from the outside. The filter 41 divides an internal space of the air cleaner case 40 into a dirty space S1 and a clean space S2. The outside air flows into the dirty space S1 through an opening of the air cleaner case 40. Clean air that passes through the filter 41 flows into the clean space S2.

The air cleaner 4 according to the present embodiment is disposed behind the internal combustion engine 3 in the front-rear direction of the vehicle 1. Specifically, the air cleaner 4 is disposed vertically below the seat frame portions 2b. More specifically, the air cleaner 4 is disposed rearward of the pivot shaft.

In the front-rear direction of the vehicle 1, the intake port of the internal combustion engine 3 is disposed on a rear side of the internal combustion engine 3. The air cleaner 4 is connected to the throttle body 5 via a pipe P1. The throttle body 5 includes a main body that defines an intake passage and an intake valve that is disposed in the intake passage and adjusts an amount of intake air to be supplied to the intake port of the internal combustion engine 3. The throttle body 5 is connected to the internal combustion engine 3 via a pipe P2, and may be directly connected to the internal combustion engine 3.

In the front-rear direction of the vehicle 1, an exhaust port of the internal combustion engine 3 is disposed on a front side of the internal combustion engine 3. The exhaust pipe 6 has one end connected to the internal combustion engine 3, and the other end connected to the muffler 7. As an example, at least one catalyst C that promotes an oxidation reaction of the exhaust gas to purify the exhaust gas is disposed inside the exhaust pipe 6. The catalyst C includes, for example, a three-way catalyst. The configuration of the catalyst C is not limited thereto. The exhaust pipe 6 is connected to the front side of the internal combustion engine 3 in the front-rear direction of the vehicle 1. In the front-rear direction of the vehicle 1, the exhaust pipe 6 further has a first portion 6a extending from the exhaust port of the internal combustion engine 3 and disposed in front of the internal combustion engine 3, and a second portion 6b extending rearward on a lateral side of the cylinder block 31 of the internal combustion engine 3 from a downstream end of the first portion 6a. The muffler 7 reduces exhaust noise of the internal combustion engine 3.

Here, the vehicle 1 includes the exhaust path 8 through which the exhaust gas from the combustion chamber 33 of the internal combustion engine 3 flows. The exhaust path 8 includes the in-engine exhaust flow path 35 of the internal combustion engine 3, an internal flow path 60 of the exhaust pipe 6, and an internal flow path 70 of the muffler 7. The in-engine exhaust flow path 35 includes the exhaust port of the internal combustion engine 3. The internal combustion engine 3 has an in-engine secondary air flow path 36 connected to the in-engine exhaust flow path 35. The in-engine secondary air flow path 36 is open to the outside of the internal combustion engine 3 at a front portion of the internal combustion engine 3 in the front-rear direction of the vehicle 1. The air cleaner 4 is disposed rearward from the internal combustion engine 3, and thus a distance from the air cleaner 4 to the in-engine secondary air flow path 36 in the secondary air flow direction is long.

The vehicle 1 further includes the secondary air flow path 9 that connects the clean space S2 of the air cleaner 4 to the exhaust path 8. The secondary air flow path 9 supplies the clean air from the clean space S2 of the air cleaner 4 to the exhaust path 8 as secondary air. The secondary air flow path 9 includes a first flow path 90 connected to the clean space S2 of the air cleaner 4 and a second flow path 91 connected to the exhaust path 8. The secondary air flow path 9 further includes an intermediate chamber 92 disposed between the first flow path 90 and the second flow path 91. The intermediate chamber 92 has an inflow port 92a connected to the first flow path 90 and an outflow port 92b connected to the second flow path 91. As an example, the intermediate chamber 92 is disposed downstream of a middle point of the secondary air flow path 9 in the flow direction.

Specifically, the vehicle 1 includes the air box 10, a first pipe 11, and a second pipe 12. The air box 10 includes the intermediate chamber 92. The first pipe 11 has an internal flow path 11a. The second pipe 12 has an internal flow path 12a. Flow path cross-section areas of the first pipe and the second pipe 12 may be the same or different. In the present embodiment, the internal flow path 11a, the intermediate chamber 92, and the internal flow path 12a are arranged in series in the secondary air flow direction of the secondary air flow path 9. In other words, the intermediate chamber 92 is interposed between the internal flow path 11a and the internal flow path 12a.

The first pipe 11 has one end connected to the air cleaner 4, and the other end connected to the air box 10. The second pipe 12 has one end connected to the air box 10, and the other end connected to the internal combustion engine 3. The internal combustion engine 3 includes a connection portion 37 that connects the other end of the second pipe 12 to the cylinder block 31. The air box 10 includes a box portion 10a that defines the intermediate chamber 92. The box portion 10a according to the present embodiment is disposed at a position overlapping the internal combustion engine 3 in a side view of the vehicle 1. Specifically, the box portion 10a is disposed at a position overlapping at least one of the cylinder block 31 and the cylinder head cover 32 in a side view of the vehicle 1.

The air box 10 includes the attachment portion 10f attached to the bracket 2d of the vehicle body frame 2. In a state where the attachment portion 10f is attached to the bracket 2d fixed to the main frame portion 2a, the air box 10 is located between the main frame portions 2a and the lower frame portion 2c in a side view of the vehicle 1. Accordingly, the air box 10 is protected from the outside by the main frame portions 2a and the lower frame portion 2c. More specifically, the air box 10 is disposed vertically below the main frame portions 2a. As an example, the air box 10 is made of resin. The air box 10 is formed by, for example, blow molding. A material and a forming method of the air box 10 are not limited thereto. The air box 10 may be constituted by a single component or a plurality of components. The air box 10 may be formed by injection molding.

The secondary air flow path 9 according to the present embodiment has the in-engine secondary air flow path 36 as a part thereof. As an example, an opening 36a of the in-engine secondary air flow path 36 is disposed on a side portion of the cylinder block 31 so as to open the in-engine secondary air flow path 36 to the outside of the internal combustion engine 3. The opening 36a is located below a lower end of the air box 10.

The vehicle 1 further includes an air switching valve V that can open and close the secondary air flow path 9, and an ECU 13 that controls the throttle body 5. The air switching valve V is disposed in the second flow path 91 of the secondary air flow path 9. The air switching valve V is of an electromagnetic valve type as an example, and an opening and closing operation thereof is controlled by the ECU 13. The air switching valve V is supported by the vehicle body frame 2. The ECU 13 is disposed in the vicinity of the air box 10.

As an example, the air switching valve V is disposed in a middle portion of the second pipe 12. Accordingly, the second pipe 12 includes an upstream pipe 14 disposed upstream of the air switching valve V and a downstream pipe 15 disposed downstream of the air switching valve V. In a side view of the vehicle 1, the upstream pipe 14 is disposed vertically above the cylinder head cover 32, and the downstream pipe 15 extends from above the cylinder head cover 32 toward the lateral side of the cylinder block 31. In a side view of the vehicle 1, the air switching valve V is located in front of the air box 10 in the front-rear direction of the vehicle 1. The air box 10 is located above a lower end of the second pipe 12. The intermediate chamber 92 is also disposed upstream of the air switching valve V in the secondary air flow path 9.

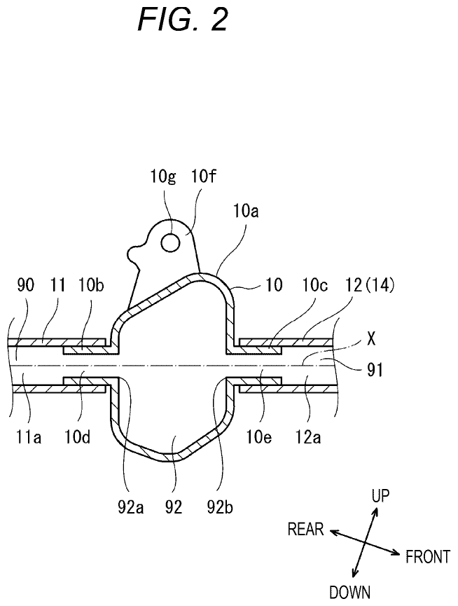

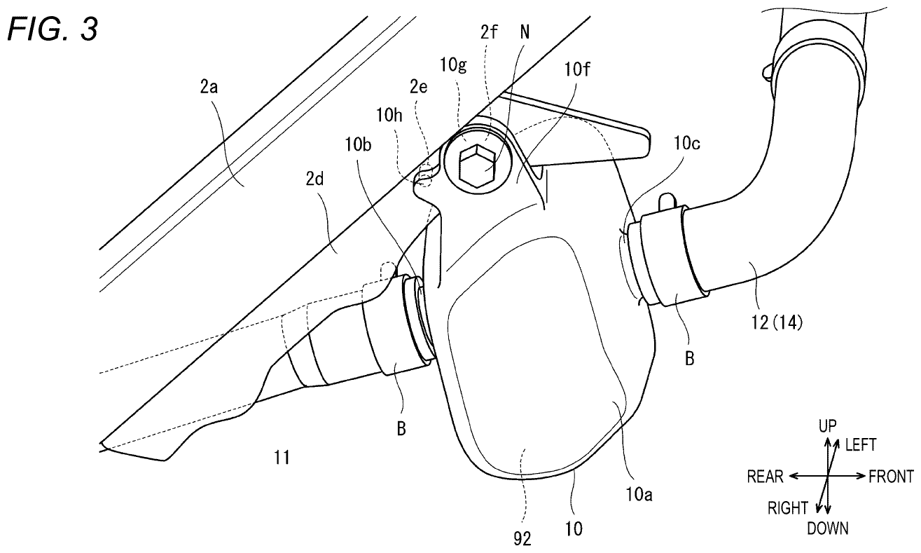

FIG. 2 is a cross-sectional view of the air box 10 in FIG. 1. For the sake of explanation, a binding member B illustrated in FIG. 3 is not illustrated in FIG. 2. As illustrated in FIG. 2, the intermediate chamber 92 of the air box 10 does not have a structure in which a flow of the secondary air is narrowed in the flow direction from the inflow port 92a toward the outflow port 92b, and a structure in which a flow of the secondary air is stopped in the flow direction. Accordingly, the secondary air flows through the entire intermediate chamber 92. As an example, with respect to a flow path cross section orthogonal to a flow path axis line X of the secondary air flow path 9, a maximum flow path cross-section area of the intermediate chamber 92 is larger than each of maximum flow path cross-section areas of the first flow path 90 and the second flow path 91.

The air box 10 includes a box portion 10a, a first protruding tubular portion 10b, and a second protruding tubular portion 10c. The box portion 10a defines the intermediate chamber 92. The first protruding tubular portion 10b and the second protruding tubular portion 10c protrude outward from the box portion 10a. The first protruding tubular portion 10b has a flow path 10d connected to the inflow port 92a. The second protruding tubular portion 10c has a flow path 10e connected to the outflow port 92b. The first pipe 11 is fitted to the first protruding tubular portion 10b. The second pipe 12 is fitted to the second protruding tubular portion 10c. Accordingly, the first flow path 90 includes the internal flow path 11a of the first pipe 11 and the flow path 10d of the first protruding tubular portion 10b. The second flow path 91 includes the internal flow path 12a of the second pipe 12 and the flow path 10e of the second protruding tubular portion 10c.

As an example, the first protruding tubular portion 10b and the second protruding tubular portion 10c each have a tubular axes extending in the front-rear direction of the vehicle 1. As an example, the inflow port 92a and the outflow port 92b overlap with each other when viewed from a flow path axis line X direction orthogonal to a flow path cross section of the inflow port 92a. In other words, the flow path axis line X of the inflow port 92a extends through the outflow port 92b. The tubular portions 10b and 10c and the pipes 11 and 12 according to the present embodiment each have a flow path cross section that is a circular shape, but the shape of the flow path cross section is not limited thereto.

FIG. 3 is an external view of the air box 10 in FIG. 1 as viewed from a diagonally forward right direction. As illustrated in FIG. 3, in the present embodiment, a size of the box portion 10a in the left-right direction of the vehicle 1 is smaller than each of sizes of the box portion 10a in the front-rear direction and the up-down direction of the vehicle 1. The attachment portion 10f extends in a longitudinal direction of the main frame portion 2a below the main frame portion 2a. The attachment portion 10f has a plate shape in which the left-right direction of the vehicle 1 is a thickness direction. The attachment portion 10f includes an insertion hole 10g that opens in the thickness direction and a columnar boss 10h that protrudes outward from a plate surface. The bracket 2d of the vehicle body frame 2 has a plate shape.

The bracket 2d has two insertion holes 2e and 2f opened in the thickness direction. In a state where the attachment portion 10f and the bracket 2d are overlapped in the thickness direction and the boss 10h is inserted into the insertion hole 2e, a fastening member N is inserted into the insertion holes 10g and 2f. The attachment portion 10f according to the present embodiment is detachably attached to the bracket 2d by the fastening member N. Further, by inserting the boss 10h into the insertion hole 2e, the air box 10 can be prevented from rotating relative to the bracket 2d in a circumferential direction of the insertion hole 10g. The first pipe 11 according to the present embodiment is fixed to the first protruding tubular portion 10b by winding a long binding member B in the circumferential direction. The second pipe 12 is fixed to the second protruding tubular portion 10c by winding the binding member B in the circumferential direction.

Returning to FIG. 1, in the vehicle 1, a pressure of the exhaust path 8 pulsates when the internal combustion engine 3 is driven. Specifically, in the exhaust path 8 of the internal combustion engine 3, a positive pressure is generated in an exhaust stroke, and a negative pressure is generated at a specific timing between the exhaust stroke and a next exhaust stroke. The negative pressure acts on the secondary air flow path 9 from the exhaust path 8, whereby the secondary air flows from the clean space S2 of the air cleaner 4 toward the exhaust path 8 of the internal combustion engine 3, and is supplied to the exhaust path 8. Oxygen contained in the secondary air is subjected to an oxidation reaction of the exhaust gas flowing through the exhaust path 8. Accordingly, the purification of the exhaust gas is promoted.

Here, the negative pressure is intermittently generated at the specific timing. A duration of the negative pressure is short. Therefore, in the related art, when the secondary air flow path 9 is long, secondary air having a sufficient flow rate cannot be drawn into the exhaust path 8 from the air cleaner 4 due to the negative pressure of the exhaust path 8.

On the other hand, the secondary air flow path 9 of the vehicle 1 according to the present embodiment includes the intermediate chamber 92 disposed between the first flow path 90 and the second flow path 91. In the secondary air flow path 9, a distance from the exhaust path 8 to the intermediate chamber 92 in the secondary air flow direction is shorter than a distance from the exhaust path 8 to the clean space S2 of the air cleaner 4. Therefore, for example, at a moment when a pressure of the exhaust path 8 of the internal combustion engine 3 becomes lower than a pressure of the secondary air flow path 9 during the operation of the internal combustion engine 3, the negative pressure is sufficiently transmitted to the intermediate chamber 92 even if the negative pressure is not sufficiently transmitted to the clean space S2 of the air cleaner 4. Therefore, when the secondary air flow path 9 is long, the secondary air having a sufficient flow rate can also be supplied from the intermediate chamber 92 to the exhaust path 8 at a low cost by using the intermediate chamber 92. As a result, it is possible to favorably purify the exhaust gas by burning unburned gas in the exhaust gas while preventing an increase in cost even when it is difficult to change a position of the air cleaner 4 due to restriction on an arrangement space.

The present embodiment can also be applied to an existing internal combustion engine including, for example, a secondary air flow path. Therefore, for example, even if no large-scale adjustment or construction is performed on the internal combustion engine, the amount of secondary air supplied to the exhaust path can be increased.

As an example, the air switching valve V according to the present embodiment is controlled by the ECU 13 so as to be in a closed state at a time other than the time of low rotation of the internal combustion engine 3 in which a negative pressure is more likely to be intermittently generated at the time of idling or the like. Accordingly, in the vehicle 1, the secondary air is adjusted not to be supplied to the exhaust path 8 at an unnecessary timing. As a result, the exhaust gas can be stably purified. An opening and closing timing of the air switching valve V is not limited, and can be set appropriately.

### Second Embodiment

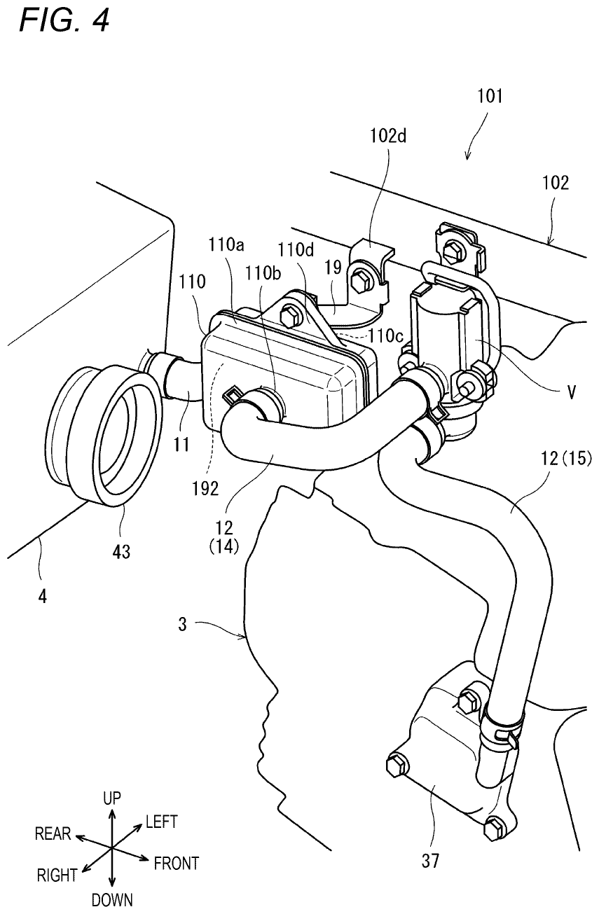

Hereinafter, differences from the first embodiment will be mainly described with reference to the second embodiment. FIG. 4 is an external view of a main part of a vehicle 101 according to the second embodiment as viewed from a diagonally forward right direction. FIG. 4 also illustrates an opening 43 of the air cleaner 4 connected to the pipe P1. The vehicle 101 includes an air box 110 having an intermediate chamber 192. A size of a box portion 110a of the air box 110 in a left-right direction of the vehicle 101 is smaller than each of sizes of the box portion 110a in a front-rear direction and an up-down direction of the vehicle 101.

The air box 110 includes a first protruding tubular portion 110b and a second protruding tubular portion 110c. The air box 110 differs from the air box 10 in that the first protruding tubular portion 110b and the second protruding tubular portion 110c each have a tubular axis that extends in a vehicle width direction of the vehicle 101. The air box 110 includes an attachment portion 110d attached to a bracket 102d of a vehicle body frame 102 via a fixture 19. The downstream pipe 15 of the second pipe 12 extends downward from the air switching valve V and is connected to the connection portion 37 of the internal combustion engine 3. In the second embodiment in which such an air box 110 is used, substantially the same effects as those of the first embodiment can also be obtained.

As described above, the embodiments have been described as examples of the technique disclosed in the present application. However, the technique disclosed in the present disclosure is not limited thereto, and is also applicable to embodiments in which changes, replacements, additions, omissions, and the like are appropriately performed. In addition, it is also possible to combine constituent elements described in the above-described embodiments to provide a new embodiment. For example, a part of a configuration in one embodiment may be applied to another configuration, and a part of a configuration in one embodiment may be freely separated and extracted from another configuration in the embodiment. Further, the constituent elements described in the accompanying drawings and the detailed description include not only constituent elements essential for solving the problem but also constituent elements that are not essential for solving the problem in order to illustrate the technique.

When the vehicle 1 or 101 is a wheeled vehicle, the wheeled vehicle is not limited to a two-wheeled vehicle. The wheeled vehicle may be a three-wheeled vehicle or a four-wheeled vehicle. The vehicle 1 or 101 may include a driving source other than the internal combustion engine 3. When the vehicle 1 or 101 is a wheeled vehicle, the vehicle 1 or 101 may be a hybrid vehicle. The vehicle may be a vehicle other than the wheeled vehicle, such as a personal watercraft. The internal combustion engine 3 may include a plurality of cylinders. The air switching valve V is not essential and may be omitted.

The secondary air flow path 9 may include a plurality of intermediate chambers. The secondary air flow path 9 may be connected to the exhaust path 8 at, for example, an intermediate portion of the exhaust pipe 6. In this case, the secondary air flow path 9 may be extended as compared with that when the secondary air flow path 9 is connected to the exhaust path 8 in the internal combustion engine 3. However, according to the present disclosure, by using the intermediate chamber 92 or 192, secondary air having a sufficient flow rate can be supplied from the intermediate chamber 92 or 192 to the exhaust path 8.

The following aspects are described as preferred embodiments of the present disclosure.

According to a first aspect of the present disclosure, a vehicle includes: an internal combustion engine having a combustion chamber; an exhaust path through which exhaust gas from the combustion chamber flows; an air cleaner having a filter that purifies outside air and a clean space into which clean air that passes through the filter flows; and a secondary air flow path that connects the clean space of the air cleaner to the exhaust path. The secondary air flow path includes: a first flow path connected to the clean space of the air cleaner; a second flow path connected to the exhaust path; and an intermediate chamber that has an inflow port connected to the first flow path and an outflow port connected to the second flow path, and that is disposed between the first flow path and the second flow path.

In the above-described configuration, in a secondary air flow direction, a distance from the exhaust path to the intermediate chamber in the secondary air flow path is shorter than a distance from the exhaust path to the clean space of the air cleaner. Therefore, for example, at a moment when a pressure of the exhaust path of the internal combustion engine becomes lower than a pressure of the secondary air flow path during the operation of the internal combustion engine, a negative pressure is sufficiently transmitted to the intermediate chamber even if a negative pressure is not sufficiently transmitted to the clean space of the air cleaner. Therefore, when the secondary air flow path is long, the secondary air having a sufficient flow rate can also be supplied from the intermediate chamber to the exhaust path at a low cost by using the intermediate chamber. Therefore, it is possible to favorably purify the exhaust gas by burning unburned gas in the exhaust gas while preventing an increase in cost even when it is difficult to change a position of the air cleaner due to restriction on an arrangement space.

According to a second aspect of the present disclosure, in the vehicle according to the first aspect, the intermediate chamber is disposed downstream of a middle point of the secondary air flow path in a flow direction.

According to the above-described configuration, the intermediate chamber is disposed downstream of the middle point of the secondary air flow path in the flow direction, whereby the intermediate chamber can be easily brought close to the exhaust path in the flow direction of the secondary air flow path. Therefore, when the moment at which the pressure of the exhaust path becomes lower than the pressure of the secondary air flow path during the operation of the internal combustion engine is shortened, the secondary air having a sufficient flow rate can also be supplied from the intermediate chamber to the exhaust path.

According to a third aspect of the present disclosure, the vehicle according to the first or second aspect further includes: an air switching valve disposed in the second flow path of the secondary air flow path and capable of opening and closing the secondary air flow path. The intermediate chamber is disposed upstream of the air switching valve in the secondary air flow path.

According to the above-described configuration, when the air switching valve is closed to stop the supply of the secondary air to the exhaust path, the secondary air can be prevented from flowing from the intermediate chamber to the exhaust path. Therefore, by opening and closing the air switching valve, the secondary air can be supplied from the intermediate chamber to the exhaust path at a preferable timing.

According to a fourth aspect of the present disclosure, in the vehicle according to any one of the first to third aspects, the inflow port and the outflow port overlap with each other when viewed from a flow path axial line direction orthogonal to a flow path cross section of the inflow port.

According to the above-described configuration, the secondary air flowing into a storage space from the first flow path through the inflow port of the intermediate chamber can be efficiently made to flow from the outflow port of the intermediate chamber toward the second flow path. Accordingly, the secondary air can be easily supplied from the intermediate chamber to the exhaust path.

According to a fifth aspect of the present disclosure, the vehicle according to any one of the first to fourth aspects further includes: an air box including the intermediate chamber having the inflow port and the outflow port; a first pipe connected to the air box and having an internal flow path; and a second pipe connected to the air box and having an internal flow path. The air box includes: a box portion that defines the intermediate chamber; a first protruding tubular portion protruding outward from the box portion and having a flow path connected to the inflow port; and a second protruding tubular portion protruding outward from the box portion and having a flow path connected to the outflow port. The first pipe is fitted to the first protruding tubular portion, the second pipe is fitted to the second protruding tubular portion. The first flow path includes the flow path of the first pipe and the flow path of the first protruding tubular portion. The second flow path includes the flow path of the second pipe and the flow path of the second protruding tubular portion.

According to the above-described configuration, the first pipe is fitted to the first protruding tubular portion of the air box, and the second pipe is fitted to the second protruding tubular portion of the air box, whereby the secondary air flow path can be formed easily and stably. For example, the air box can be easily constructed by integrally forming the box portion, the first protruding tubular portion, and the second protruding tubular portion.

According to a sixth aspect of the present disclosure, in the vehicle according to the fifth aspect, a size of the box portion of the air box in a left-right direction of the vehicle is smaller than each of sizes of the box portion of the air box in a front-rear direction and an up-down direction of the vehicle.

According to the above-described configuration, it is possible to prevent the vehicle from being increased in size in the left-right direction by the air box, and to easily dispose the air box in a limited space of the vehicle. Therefore, a degree of freedom in designing the arrangement space of the air box can be improved.

According to a seventh aspect of the present disclosure, in the vehicle according to any one of the first to sixth aspects, the air cleaner is disposed behind the internal combustion engine in the front-rear direction of the vehicle. The internal combustion engine has an in-engine exhaust flow path which is a part of the exhaust path, and an in-engine secondary air flow path which is a part of the secondary air flow path and is connected to the in-engine exhaust flow path. The in-engine secondary air flow path is open outward of the internal combustion engine at a front portion of the internal combustion engine in the front-rear direction of the vehicle.

According to the above-described configuration, a pipe constituting a part of the secondary air flow path is connected to the in-engine secondary air flow path at the front portion of the internal combustion engine, and thus a distance from the air cleaner at the rear of the internal combustion engine to the in-engine secondary air flow path becomes long, and the negative pressure is less likely to be transmitted from the exhaust path to the clean space of the air cleaner, but due to the presence of the intermediate chamber, the secondary air having a sufficient flow rate can be supplied to the exhaust path including the in-engine exhaust flow path. Therefore, the exhaust gas can be favorably purified by burning the unburned gas in the exhaust gas.

According to an eighth aspect of the present disclosure, the vehicle according to any one of the first to seventh aspects further includes: a vehicle body frame having a bracket; and an air box having the intermediate chamber. The air box includes an attachment portion attached to the bracket.

According to the above-described configuration, the air box can be supported more stably on the vehicle body frame by using the attachment portion of the air box and the bracket of the vehicle body frame. Therefore, when the vehicle body vibrates or when an external force acts on the vehicle body, the secondary air can be stably supplied to the exhaust path from the intermediate chamber provided in the air box while maintaining a relative position of the air box with respect to the vehicle body frame.

What is claimed is:

1. A vehicle comprising:
an internal combustion engine having a combustion chamber;
an exhaust path through which exhaust gas from the combustion chamber flows;
an air cleaner having a filter that purifies outside air and a clean space into which clean air that passes through the filter flows; and
a secondary air flow path that connects the clean space of the air cleaner to the exhaust path, wherein
the secondary air flow path includes:
a first flow path connected to the clean space of the air cleaner;
a second flow path connected to the exhaust path; and
an intermediate chamber that has an inflow port connected to the first flow path and an outflow port connected to the second flow path, and that is disposed between the first flow path and the second flow path.

2. The vehicle according to claim 1, wherein
the intermediate chamber is disposed downstream of a middle point of the secondary air flow path in a flow direction.

3. The vehicle according to claim 1, further comprising:
an air switching valve disposed in the second flow path of the secondary air flow path and capable of opening and closing the secondary air flow path, wherein
the intermediate chamber is disposed upstream of the air switching valve in the secondary air flow path.

4. The vehicle according to claim 1, wherein
the inflow port and the outflow port overlap with each other when viewed from a flow path axial line direction orthogonal to a flow path cross section of the inflow port.

5. The vehicle according to claim 1, further comprising:
an air box including the intermediate chamber having the inflow port and the outflow port;
a first pipe connected to the air box and having an internal flow path; and
a second pipe connected to the air box and having an internal flow path, wherein the air box includes:
a box portion that defines the intermediate chamber;
a first protruding tubular portion protruding outward from the box portion and having a flow path connected to the inflow port; and
a second protruding tubular portion protruding outward from the box portion and having a flow path connected to the outflow port,
the first pipe is fitted to the first protruding tubular portion, the second pipe is fitted to the second protruding tubular portion,
the first flow path includes the internal flow path of the first pipe and the flow path of the first protruding tubular portion, and
the second flow path includes the internal flow path of the second pipe and the flow path of the second protruding tubular portion.

6. The vehicle according to claim 5, wherein
a size of the box portion of the air box in a left-right direction of the vehicle is smaller than each size of the box portion of the air box in a front-rear direction and an up-down direction of the vehicle.

7. The vehicle according to claim 1, wherein
the air cleaner is disposed behind the internal combustion engine in a front-rear direction of the vehicle,
the internal combustion engine has an in-engine exhaust flow path which is a part of the exhaust path, and an in-engine secondary air flow path which is a part of the secondary air flow path and is connected to the in-engine exhaust flow path, and
the in-engine secondary air flow path is open outward of the internal combustion engine at a front portion of the internal combustion engine in the front-rear direction of the vehicle.

8. The vehicle according to claim 1, further comprising:
a vehicle body frame having a bracket; and
an air box having the intermediate chamber, wherein
the air box includes an attachment portion attached to the bracket.

9. The vehicle according to claim 1, wherein
with respect to a flow path cross section orthogonal to a flow path axis line of the secondary air flow path, a maximum flow path cross-section area of the intermediate chamber is larger than each of maximum flow path cross-section areas of the first flow path and the second flow path.
